(19) United States
(12) Patent Application Publication
(10) Pub. No.: US 2022/0379969 A1
(43) Pub. Date: Dec. 1, 2022

(54) VEHICLE BODY STRUCTURE FOR SUSPENSION MOUNTING

(71) Applicants: Hyundai Motor Company, Seoul (KR); Kia Corporation, Seoul (KR)

(72) Inventor: Hae Hoon Lee, Suwon (KR)

(21) Appl. No.: 17/510,768

(22) Filed: Oct. 26, 2021

(30) Foreign Application Priority Data
May 31, 2021 (KR) 10-2021-0070367

(51) Int. Cl. B62D 25/08; B62D 25/16; B62D 25/18; B62D 27/02

(52) U.S. Cl. CPC B62D 25/088; B62D 25/163; B62D 25/18; B62D 27/023; B62D 25/02

(57) ABSTRACT

A vehicle body structure for suspension mounting includes a cross-sectional structure and a connecting structure of a vehicle body on which a rear suspension is mounted that exhibits vehicle body strength with a reduced number of components. A mounting panel is provided on a wheel housing panel and has a plurality of mounting holes through which a top portion of a suspension extends so as to be mounted on the mounting panel. A reinforcing unit is provided in the mounting panel and has a shape of a ring surrounding the mounting holes.

### CROSS REFERENCE TO RELATED APPLICATION

The present application claims under 35 U.S.C. § 119(a) the benefit of Korean Patent Application No. 10-2021-0070367, filed May 31, 2021, the entire contents of which are incorporated by reference herein.

### BACKGROUND

### (a) Technical Field

The present disclosure generally relates to a vehicle body structure for suspension mounting, in which a cross-sectional structure and a connecting structure of a vehicle body on which a rear suspension is mounted exhibit improved vehicle body strength while reducing a number of components.

### (b) Description of the Related Art

A suspension of a vehicle is supported between an axle connected to a tire and a vehicle body portion. The suspension serves to prevent vibrations or impacts occurring from the road during driving of the vehicle from being transmitted to the vehicle body, thereby preventing a vehicle body from being damaged and improving ride comfort. The suspension is categorized into a front suspension and a rear suspension

Referring to a structure by which the rear suspension is mounted on the vehicle, a top portion of a shock absorber of the rear suspension is mounted on a wheel housing.

Several layers of brackets and reinforcing members are stacked and fixed on the wheel housing on which the top portion of the shock absorber is mounted. Mounting holes are formed in overlapping portions such that the top portion of the shock absorber extends through the mounting holes to be mounted on the wheel housing.

Here, a peripheral portion of the mounting hole is an input point on which a load is concentrated in a Z-axial direction while the vehicle is driving. The reinforcing members stacked in a plurality of layers provide strength to a Z-axial input point.

However, this reinforcing structure has a problem of an increased number of components, thereby causing production cost and an overall weight to be increased.

Furthermore, a sidewall of the wheel housing panel has an input point on which a load is concentrated in a Y-axial direction. Since a Y-axial input point has a weak coupling structure, it is required to reinforce the strength of a corresponding portion.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure proposes a vehicle body structure for suspension mounting, in which a cross-sectional structure and a connecting structure of a vehicle body on which a rear suspension is mounted exhibit improved body strength while reducing a number of components.

In order to achieve the above objective, according to one aspect of the present disclosure, there is provided a vehicle body structure for suspension mounting, the structure including: a mounting panel provided on a wheel housing panel and having a plurality of mounting holes through which a top portion of a suspension extends so as to be mounted on the mounting panel; and a reinforcing unit provided in the mounting panel and having a shape of a ring surrounding the mounting holes.

The reinforcing unit may be defined as a space having a closed section defined therein.

The mounting panel may include: a mounting bracket fixedly provided and configured to cover a fixing recess provided on an upper portion of the wheel housing panel; and a mounting reinforcing member seated on and fixed to a top surface of the mounting bracket. The reinforcing unit may be provided between the mounting bracket and the mounting reinforcing member.

Portions of an internal area and an external area of the reinforcing unit in which the mounting bracket and the mounting reinforcing member overlap may be bonded by welding.

The top portion of the suspension may be fastened to a top surface of the mounting panel by a fastening member. A top end of the reinforcing unit may protrude in a shape surrounding the fastening member.

The vehicle body structure may further include a panel reinforcing member provided on a side surface of the wheel housing panel. One end of the mounting bracket and one end of the mounting reinforcing member may extend downward along the side surface of the wheel housing panel. At least three components from among the wheel housing panel, the panel reinforcing member, the mounting bracket, and the mounting reinforcing member may be bonded by welding, thereby forming welds.

A top end of an internal wall surface of the mounting reinforcing member may overlap a top end of an external wall surface of the wheel housing panel. A bottom end of an internal wall surface of the panel reinforcing member may overlap a bottom end of an external wall surface of the wheel housing panel. A top end of an external wall surface of the mounting reinforcing member and an internal wall surface of the mounting bracket may overlap each other. A bottom end of the external wall surface of the mounting reinforcing member and a bottom end of the internal wall surface of the panel reinforcing member may overlap each other. A top end of an external wall surface of the panel reinforcing member may overlap an external wall surface of the mounting bracket.

The welds may be provided by welding the at least three components including the mounting reinforcing member, each of the welds being provided in a plurality of locations along a vertical longitudinal direction of the mounting reinforcing member.

A top weld from among the welds may be formed by welding three components including the panel reinforcing member, the mounting bracket, and the mounting reinforcing member.

An intermediate weld from among the welds may be formed by welding three components including the mounting bracket, the mounting reinforcing member, and the wheel housing panel.

A bottom weld may be formed by welding three components including the panel reinforcing member, the mounting reinforcing member, and the wheel housing panel.

As set forth above, according to the present disclosure, the cross-section of the vehicle body on which the top portion of the suspension has the shape of a ring having a closed cross-sectional structure by which strength and loads may be easily distributed. Thus, the strength of a Z-directional input point may be reinforced by increasing the surface strength of the mounting portion on which the suspension is mounted without increases in the number of components of the mounting portion. In addition, loads transmitted from the top end of the suspension in the direction of the C-pillar may be efficiently distributed.

In addition, the connection between the top end and the side portion of the wheel housing panel may be strengthened, thereby reinforcing the strength of a Y-axial input point of the side surface of the wheel housing panel. Consequently, loads transmitted along the panel reinforcing member from the top end of the suspension may be more efficiently distributed.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view illustrating a vehicle body section on which a rear suspension is mounted according to the present disclosure, viewed from inside of a vehicle;

FIG. 2 is an enlarged view of a portion of the vehicle body section on which the rear suspension is mounted according to the present disclosure;

FIG. 3 is a cross-sectional view taken along the line A-A in FIG. 1;

FIG. 4 is an exploded view illustrating the vehicle body section on which the rear suspension is mounted according to the present disclosure;

FIG. 5 a view illustrating the vehicle body section on which the rear suspension is mounted according to the present disclosure, viewed from outside the vehicle; and

FIG. 6 is a cross-sectional view taken along the line B-B in FIG. 1.

### DETAILED DESCRIPTION OF THE DISCLOSURE

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Specific structural and functional descriptions of embodiments of the present disclosure disclosed herein are only for illustrative purposes of the embodiments of the present disclosure.

The present disclosure may be embodied in many different forms without departing from the spirit and significant characteristics of the present disclosure. Therefore, the embodiments of the present disclosure are disclosed only for illustrative purposes and should not be construed as limiting the present disclosure.

Reference will now be made in detail to various embodiments of the present disclosure, specific examples of which are illustrated in the accompanying drawings and described below, since the embodiments of the present disclosure can be variously modified in many different forms. While the present disclosure will be described in conjunction with exemplary embodiments thereof, it is to be understood that the present description is not intended to limit the present disclosure to those exemplary embodiments. On the contrary, the present disclosure is intended to cover not only the exemplary embodiments, but also various alternatives, modifications, equivalents and other embodiments that may be included within the spirit and scope of the present disclosure as defined by the appended claims.

It will be understood that, although the terms “first”, “second”, etc. may be used herein to describe various elements, these elements should not be limited by these terms. These terms are only used to distinguish one element from another element. For instance, a first element discussed below could be termed a second element without departing from the teachings of the present disclosure. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between”, “directly between”, “adjacent to”, or “directly adjacent to” should be construed in the same way.

Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary embodiments of the present disclosure will be described in detail with reference to the accompanying drawings.

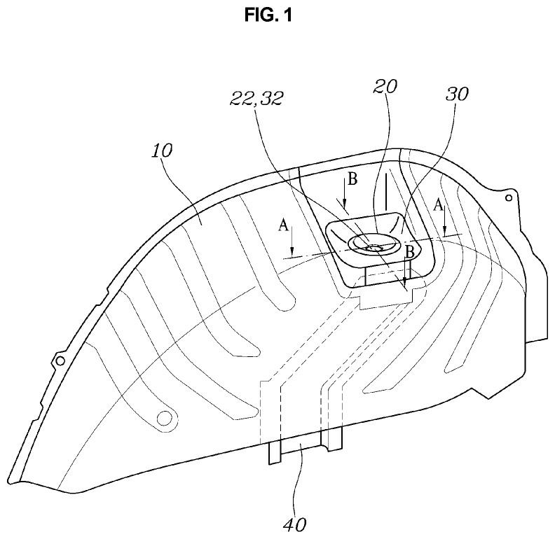

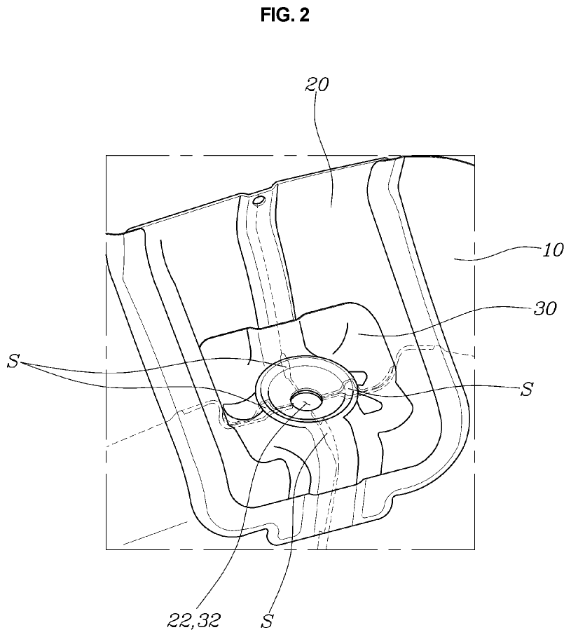

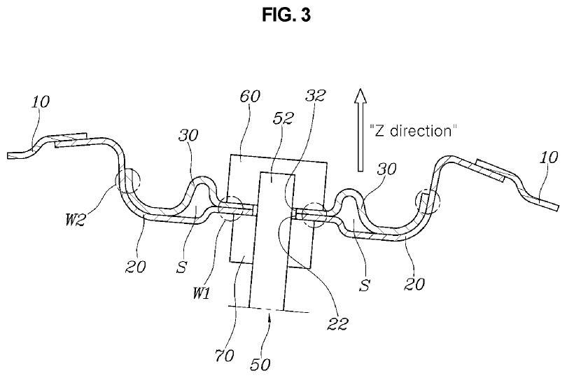

FIG. 1 is a view illustrating a vehicle body section on which a rear suspension 50 is mounted according to the present disclosure, viewed from inside of a vehicle, FIG. 2 is an enlarged view of a portion of the vehicle body section on which the rear suspension 50 is mounted according to the present disclosure, and FIG. 3 is a cross-sectional view taken along the line A-A in FIG. 1.

Referring to FIG. 1, a vehicle body structure allowing the rear suspension 50 to be mounted thereon according to the present disclosure includes: a mounting panel provided on a wheel housing panel 10 and having mounting holes 22 and 32 through which a top portion 52 of the rear suspension 50 extends so as to be mounted on the mounting panel; and a reinforcing unit S provided in the mounting panel and having a shape of a ring surrounding the mounting holes 22 and 32.

For example, the mounting panel is fixed to an intermediate portion of the top end of the rear wheel housing panel 10, the mounting holes 22 are formed in an intermediate portion of the mounting panel, and top portion 52 of a shock absorber of the rear suspension 50 extends through the mounting holes 22 and 32.

In addition, a fastening member 60 is supported on the top surface of the mounting panel while being fastened to the top end of the shock absorber, and a bush 70 is supported to the bottom surface of the mounting panel. Here, the fastening member 60 has a nut fixedly provided on the internal portion thereof and thus is fastened to the top portion 52 of the shock absorber using a bolt fastening structure. A rubber material surrounds the outer surface of the nut.

In particular, the present disclosure has the reinforcing unit S having the shape of a ring surrounding the mounting holes 22 and 32.

In addition, the reinforcing unit S has defined therein a space having a closed section.

That is, since the cross-section of the mounting panel on which the shock absorber is mounted has the shape of a ring having a closed cross-sectional structure by which strength and loads may be easily distributed, the strength of a Z-axial input point is reinforced by increasing the surface strength of the mounting portion without increases in the number of components.

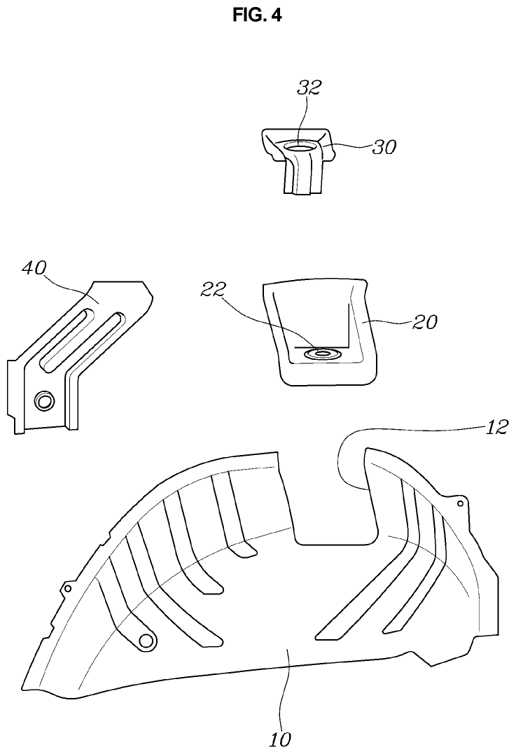

In addition, FIG. 4 is an exploded view illustrating the vehicle body section on which the rear suspension 50 is mounted according to the present disclosure.

Referring to FIG. 4 together with FIG. 3, the mounting panel includes: a mounting bracket 20 configured to cover a fixing recess 12 formed on the upper portion of the wheel housing panel 10 and fixed to the wheel housing panel 10; and a mounting reinforcing member 30 seated on and fixed to the top surface of the mounting bracket 20.

In addition, the reinforcing unit S may be provided between the mounting bracket 20 and the mounting reinforcing member 30.

Specifically, the U-shaped fixing recess 12 is provided in the intermediate portion of the top portion of the wheel housing panel 10 that faces outward. The outer peripheral portions of the mounting bracket 20 are fixedly provided on the internal surface of the fixing recess 12.

Here, the intermediate portion of the mounting bracket 20 is indented downward so as to have an L-shaped cross-section. In a portion of the mounting bracket 20 forming the bottom surface due to the L-shaped cross-section, the mounting hole 22 is formed.

In addition, the mounting reinforcing member 30 is fixed to while overlapping the top surface of the mounting bracket 20. Thus, the mounting hole 32 is formed in an intermediate portion of the mounting reinforcing member 30. The mounting reinforcing member 30 is fixed in a position in which the position of the mounting hole 32 corresponds to the position of the mounting hole 22 of the mounting bracket 20.

That is, the vehicle body portion to which the shock absorber is fixed is fixed only using the mounting bracket 20 and the mounting reinforcing member 30. Thus, the vehicle body structure for fixing the shock absorber may be simplified to reduce the number of components compared to that of the conventional vehicle body structure, thereby reducing production cost and weight.

In addition, as illustrated in FIG. 3, portions of the internal area and the external area of the reinforcing unit S in which the mounting bracket 20 and the mounting reinforcing member 30 overlap are bonded by welding.

That is, inner and outer portions of the ring-shaped reinforcing unit S in which the mounting bracket 20 and the mounting reinforcing member 30 overlap are bonded by welding, thereby forming welds W1 and W2. Consequently, this configuration may prevent the reinforcing unit S having the closed cross-sectional structure from being deformed, thereby reliably maintaining the function of the reinforcing unit S.

Furthermore, the top portion 52 of the rear suspension 50 may be fastened to the top surface of the mounting panel by the fastening member 60. The top end of the reinforcing unit S may protrude in a shape surrounding the fastening member 60.

That is, the reinforcing unit S has a sufficient size to surround the peripheral portions of the fastening member 60. Thus, the fastening member 60 may be fastened to the rear suspension 50 without interfering with the reinforcing unit S, and loads transmitted from the top end of the rear suspension 50 in the direction of the C-pillar above the mounting bracket 20 may be more efficiently distributed.

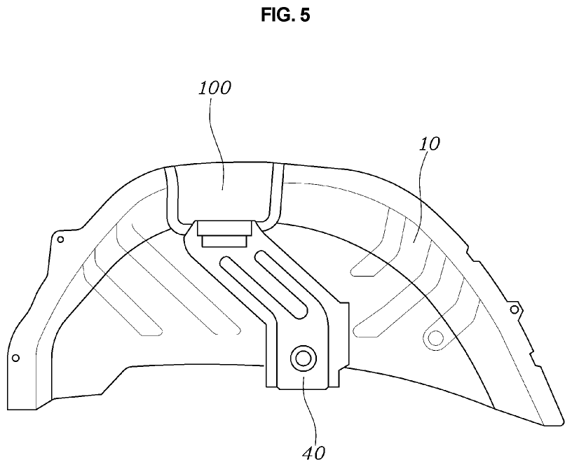

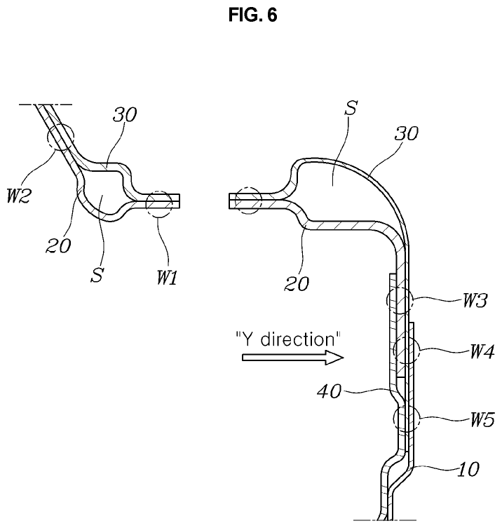

FIG. 4 is an exploded view illustrating the vehicle body section on which the rear suspension 50 is mounted according to the present disclosure, FIG. 5 a view illustrating the vehicle body section on which the rear suspension 50 is mounted according to the present disclosure, viewed from outside the vehicle; and FIG. 6 is a cross-sectional view taken along the line B-B in FIG. 1.

Referring to FIGS. 4 to 6, a panel reinforcing member 40 is further provided on the side surface of the wheel housing panel 10.

In addition, one end of the mounting bracket 20 and one end of the mounting reinforcing member 30 extend downward along the side surface of the wheel housing panel 10. At least three from among the wheel housing panel 10, the panel reinforcing member 40, the mounting bracket 20, and the mounting reinforcing member 30 are bonded by welding, thereby forming welds W3, W4, and W5 arranged sequentially.

For example, one end of the mounting bracket 20 extending toward the vehicle body side is bent downward along the sidewall of the wheel housing panel 10.

In addition, one end of the mounting reinforcing member 30 extending toward the vehicle body side is bent downward along the sidewall of the wheel housing panel 10.

Consequently, portions of the wheel housing panel 10, the panel reinforcing member 40, the mounting bracket 20, and the mounting reinforcing member 30 overlap each other, and at least three components from among these overlapping components are welded.

That is, the mounting bracket 20 and the mounting reinforcing member 30 on which the top portion 52 of the rear suspension 50 is mounted are welded to at least one of the wheel housing panel and the panel reinforcing member 40 on the sidewall of the wheel housing panel 10, thereby connecting the top end and the side surface of the wheel housing panel 10.

That is, the mounting bracket 20 on which the top portion 52 of the rear suspension 50 is mounted and the mounting reinforcing member 30 are welded to at least one of the wheel housing panel 10 and the panel reinforcing member 40, thereby connecting the top end and the side surface of the wheel housing panel 10.

Accordingly, the connection between the top end and the side portion of the wheel housing panel 10 may be strengthened, thereby reinforcing the strength of a Y-axial input point of the side surface of the wheel housing panel 10. Consequently, loads transmitted along the panel reinforcing member 40 from the top end of the rear suspension 50 may be more efficiently distributed.

Furthermore, with reference to FIG. 6, the wheel housing panel 10, the panel reinforcing member 40, the mounting bracket 20, and the mounting reinforcing member 30 have the following positional relationship. That is, the top end of the internal wall surface of the mounting reinforcing member 30 overlaps the top end of the external wall surface of the wheel housing panel 10, the bottom end of the internal wall surface of the panel reinforcing member 40 overlaps the bottom end of the external wall surface of the wheel housing panel 10, the top end of the external wall surface of the mounting reinforcing member 30 and the internal wall surface of the mounting bracket 20 overlap each other, the bottom end of the external wall surface of the mounting reinforcing member 30 and the bottom end of the internal wall surface of the panel reinforcing member 40 overlap each other, and the top end of the external wall surface of the panel reinforcing member 40 overlaps the external wall surface of the mounting bracket 20.

According to this positional structure, specific portions of at least three from among the wheel housing panel 10, the panel reinforcing member 40, the mounting bracket 20, and the mounting reinforcing member 30 overlap each other. The overlapping at least three components are locally welded, thereby forming the welds W3, W4, and W5.

Here, each of the welds W3, W4, and W5 is formed by welding the at least three components including the mounting reinforcing member 30. Each of the welds W3, W4, and W5 to may be provided in a plurality of locations along the vertical longitudinal direction of the mounting reinforcing member 30.

That is, the mounting reinforcing member 30 and two components from among the wheel housing panel 10, the panel reinforcing member 40, and the mounting bracket 20 overlapping the mounting reinforcing member 30 are welded. Consequently, a triple structure of three layers is formed in each of the welds W3, W4, and W5.

The top weld W3, located at the uppermost position, from among the welds W3, W4, and W5, may be formed by welding three components including the panel reinforcing member 40, the mounting bracket 20, and the mounting reinforcing member 30.

That is, the panel reinforcing member 40, the mounting bracket 20, and the mounting reinforcing member 30 are sequentially overlapped and bonded by welding, thereby forming the top weld W3.

In addition, the intermediate weld W4 may be formed by welding three components including the mounting bracket 20, the mounting reinforcing member 30, and the wheel housing panel 10.

That is, the weld W4 is formed by sequentially overlapping and then welding the mounting bracket 20, the mounting reinforcing member 30, and the wheel housing panel 10.

In addition, the bottom weld W5 may be formed by welding three components including the panel reinforcing member 40, the mounting reinforcing member 30, and the wheel housing panel 10.

That is, the bottom weld W5 is formed by sequentially overlapping and then welding the panel reinforcing member 40, the mounting reinforcing member 30, and the wheel housing panel 10.

As set forth above, according to the present disclosure, the cross-section of the vehicle body on which the top portion 52 of the rear suspension 50 has the shape of a ring having a closed cross-sectional structure by which strength and loads may be easily distributed. Thus, the strength of the Z-directional input point may be reinforced by increasing the surface strength of the mounting portion on which the rear suspension 50 is mounted without increases in the number of components of the mounting portion. In addition, loads transmitted from the top end of the rear suspension 50 in the direction of the C-pillar may be efficiently distributed.

In addition, the connection between the top end and the side portion of the wheel housing panel 10 may be strengthened, thereby reinforcing the strength of the Y-axial input point of the side surface of the wheel housing panel 10. Consequently, loads transmitted along the panel reinforcing member 40 from the top end of the rear suspension 50 may be more efficiently distributed.

Although the exemplary embodiments of the present disclosure have been described for illustrative purposes, those skilled in the art will appreciate that various modifications, additions, and substitutions are possible, without departing from the scope and spirit of the present disclosure as disclosed in the accompanying claims.

What is claimed is:

1. A vehicle body structure for suspension mounting, the vehicle body structure comprising:
a mounting panel provided on a wheel housing panel and having a plurality of mounting holes through which a top portion of a suspension extends so as to be mounted on the mounting panel; and
a reinforcing unit provided in the mounting panel and having a shape of a ring surrounding the mounting holes.

2. The vehicle body structure of claim 1, wherein the reinforcing unit comprises a space having a closed section defined therein.

3. The vehicle body structure of claim 2, wherein the mounting panel comprises:
a mounting bracket fixedly provided and configured to cover a fixing recess provided on an upper portion of the wheel housing panel; and
a mounting reinforcing member seated on and fixed to a top surface of the mounting bracket,
wherein the reinforcing unit is provided between the mounting bracket and the mounting reinforcing member.

4. The vehicle body structure of claim 3, wherein portions of an internal area and an external area of the reinforcing unit in which the mounting bracket and the mounting reinforcing member overlap are bonded by welding.

5. The vehicle body structure of claim 1, wherein the top portion of the suspension is fastened to a top surface of the mounting panel by a fastening member, and
a top end of the reinforcing unit protrudes in a shape surrounding the fastening member.

6. The vehicle body structure of claim 3, further comprising:
a panel reinforcing member provided on a side surface of the wheel housing panel,
wherein one end of the mounting bracket and one end of the mounting reinforcing member extend downward along the side surface of the wheel housing panel, and at least three components from among the wheel housing panel, the panel reinforcing member, the mounting bracket, and the mounting reinforcing member are bonded by welding, thereby forming welds.

7. The vehicle body structure of claim 6, wherein a top end of an internal wall surface of the mounting reinforcing member overlaps a top end of an external wall surface of the wheel housing panel,
a bottom end of an internal wall surface of the panel reinforcing member overlaps a bottom end of an external wall surface of the wheel housing panel,
a top end of an external wall surface of the mounting reinforcing member and an internal wall surface of the mounting bracket overlap each other,
a bottom end of the external wall surface of the mounting reinforcing member and a bottom end of the internal wall surface of the panel reinforcing member overlap each other, and
a top end of an external wall surface of the panel reinforcing member overlaps an external wall surface of the mounting bracket.

8. The vehicle body structure of claim 6, wherein the welds are provided by welding the at least three components including the mounting reinforcing member, each of the welds being provided in a plurality of locations along a vertical longitudinal direction of the mounting reinforcing member.

9. The vehicle body structure of claim 8, wherein a top weld from among the welds is formed by welding three components including the panel reinforcing member, the mounting bracket, and the mounting reinforcing member.

10. The vehicle body structure of claim 8, wherein an intermediate weld from among the welds is formed by welding three components including the mounting bracket, the mounting reinforcing member, and the wheel housing panel.

11. The vehicle body structure of claim 8, wherein a bottom weld is formed by welding three components including the panel reinforcing member, the mounting reinforcing member, and the wheel housing panel.
